(19) United States
(12) Patent Application Publication
(10) Pub. No.: US 2019/0193552 A1
(43) Pub. Date: Jun. 27, 2019

(54) VEHICLE DRIVE APPARATUS

(71) Applicant: Honda Motor Co., Ltd., Tokyo (JP)

(72) Inventor: Andrii Pydin, Wako-shi (JP)

(21) Appl. No.: 16/216,926

(22) Filed: Dec. 11, 2018

(30) Foreign Application Priority Data
Dec. 22, 2017 (JP) 2017-245761

(51) Int. Cl. B60K 7/00; H02K 7/116; B60K 6/26

(52) U.S. Cl. CPC B60K 7/0007; B60K 6/42; B60K 6/26; H02K 7/116

(57) ABSTRACT

A vehicle drive apparatus including an electric motor including a rotor rotating about an axial line extending in a vertical direction and a stator disposed around the rotor, a shaft disposed rotatably about the axial line inside the rotor and extended along the axial line, a torque transmission mechanism configured to transmit a torque of the electric motor to the shaft, a case including a side wall and a bottom wall and configured to surround the stator, and a bearing attached to the bottom wall to support a bottom portion of the rotor rotatably about the axial line while bearing a weight of the rotor.

### CROSS-REFERENCE TO RELATED APPLICATION

This application is based upon and claims the benefit of priority from Japanese Patent Application No. 2017-245761 filed on Dec. 22, 2017, the content of which is incorporated herein by reference.

### BACKGROUND OF THE INVENTION

### Field of the Invention

This invention relates to a vehicle drive apparatus for driving a vehicle by an electric motor.

### Description of the Related Art

Conventionally, there is a known vehicle drive apparatus of this type, in which an electric motor is mounted under a vehicle seat in a state with an axis of rotation of the motor oriented in vehicle height direction and torque of the motor is transmitted to a propeller shaft through a shaft installed in the center of a rotor of the motor and a pair of bevel gears. Such an apparatus is described in Japanese Unexamined Patent Publication No. 2012-029369 (JP2012-029369A), for example.

However, when the motor is mounted in the state with the axis of rotation oriented in vehicle height direction like the apparatus described in JP2012-029369A, it is necessary to rotatably support the rotor of the motor around the shaft via a bearing while bearing a weight of the rotor. Therefore, bearing loss is likely to become larger.

### SUMMARY OF THE INVENTION

An aspect of the present invention is a vehicle drive apparatus including: an electric motor including a rotor rotating about an axial line extending in a vertical direction and a stator disposed around the rotor; a shaft disposed rotatably about the axial line inside the rotor and extended along the axial line; a torque transmission mechanism configured to transmit a torque of the electric motor to the shaft; a case including a side wall and a bottom wall and configured to surround the stator; and a bearing attached to the bottom wall to support a bottom portion of the rotor rotatably about the axial line while bearing a weight of the rotor.

### BRIEF DESCRIPTION OF THE DRAWINGS

The objects, features, and advantages of the present invention will become clearer from the following description of embodiments in relation to the attached drawings, in which:

FIG. 1 is a front view showing schematically main configurations of a vehicle drive apparatus according to an embodiment of the invention;

FIG. 2 is a side view showing an example of installation of the vehicle drive apparatus of FIG. 1 in the vehicle;

FIG. 3 is a cross-sectional diagram showing schematically a main configuration of the vehicle drive apparatus of FIG. 1;

FIG. 4A is an enlarged view of region IV of FIG. 3;

FIG. 4B is an enlarged view of region A of FIG. 4A;

FIG. 5 is an exploded perspective view of a main part of FIG. 3;

FIG. 6 is an example for a comparison with FIG. 3; and

FIG. 7 is a diagram showing a modification of FIG. 3.

### DETAILED DESCRIPTION OF THE INVENTION

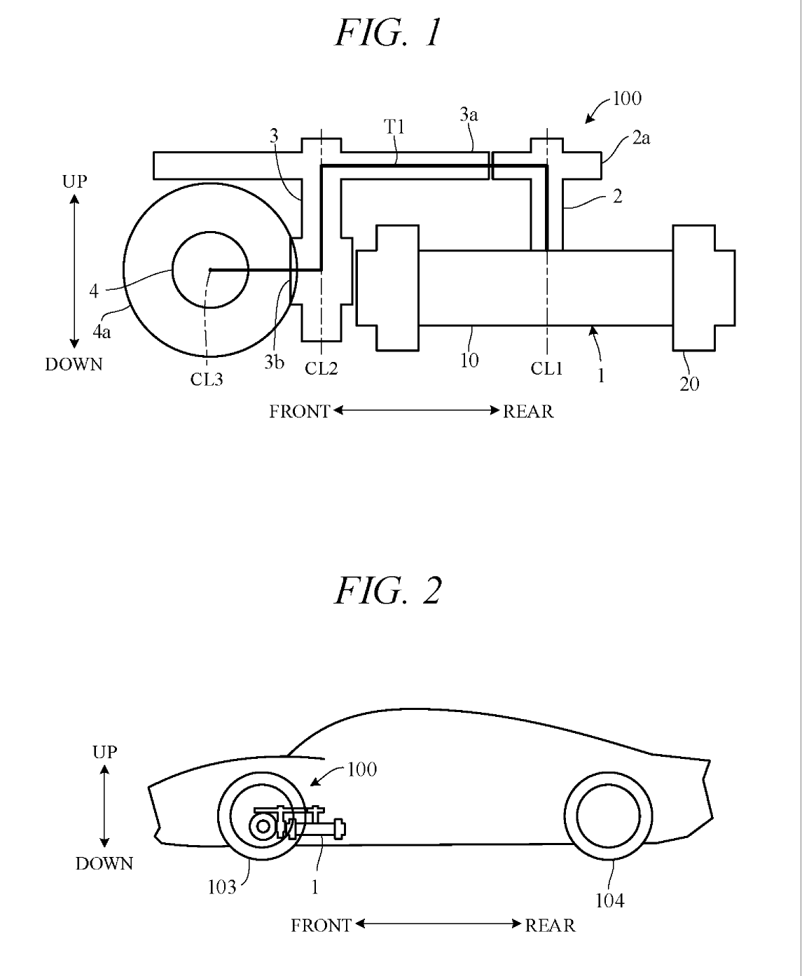

Hereinafter, an embodiment of the present invention is explained with reference to FIGS. 1 to 7. FIG. 1 is a front view showing schematically main configurations of a vehicle drive apparatus 100 according to an embodiment of the present invention. The vehicle drive apparatus 100 includes an electric motor 1 and is configured to output torque from the electric motor 1 to driving wheels of a vehicle. Therefore, the vehicle drive apparatus 100 is mounted on an electric vehicle, hybrid vehicle or other vehicle having the electric motor 1 as a drive (propulsion) power source. The electric motor 1 is also used as a generator.

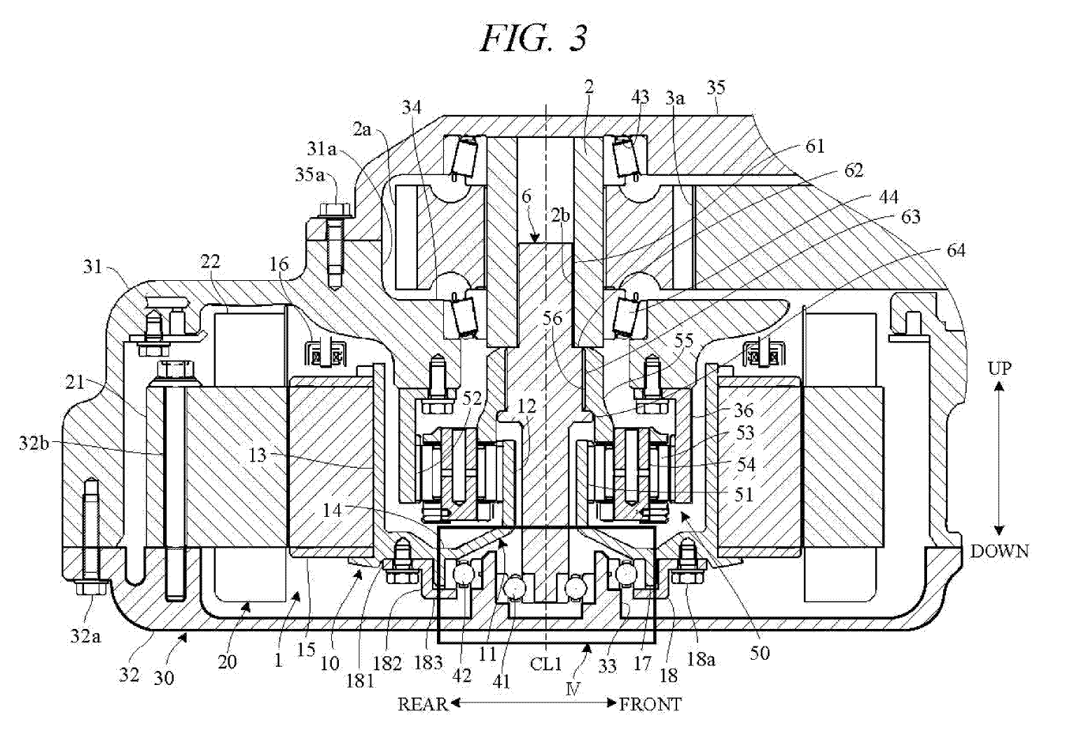

FIG. 2 is a side view showing an example of installation of the vehicle drive apparatus 100 in the vehicle. In FIG. 2, the vehicle drive apparatus 100 is installed between left and right front wheels 103 for use as a front wheel drive unit. The vehicle drive apparatus 100 can be also installed between left and right rear wheels 104 for use as a rear wheel drive unit.

As shown in FIG. 2, the vehicle drive apparatus 100 is arranged near a bottom surface of the body and at the middle in left-right direction of the vehicle. Therefore, height of the vehicle hood can be lowered to realize enhanced superiority of design and the like. Further, although illustrating is omitted, without arising to raise the floor surface inside the vehicle, i.e., narrowing an inside space of the vehicle, it is possible to easily install the vehicle drive apparatus 100 even below the seat or between left and right rear wheels 104. As a result, a degree of freedom for arrangement of the vehicle drive apparatus 100 is fine.

Front-rear, up-down and left-right directions of the vehicle drive apparatus 100 respectively correspond to front-rear (vehicle length), up-down (vehicle height) and left-right (vehicle width) directions of the vehicle under a condition that the vehicle drive apparatus 100 is mounted on the vehicle, for example. Up-down direction and left-right direction are also called vertical direction and lateral direction.

As shown in FIG. 1, the electric motor 1 includes a rotor 10 that rotates around an axis CL1 extending in vertical direction and a stator 20 disposed around the rotor 10. A first gear shaft 2 is coupled to an output shaft of the motor 1. The first gear shaft 2 extends along the axis CL1 to project upward of the motor 1 and is provided at its upper end portion with a first gear 2a of smaller diameter than the rotor 10 of the motor 1. The first gear 2a is, for example, configured as a spur gear.

A second gear shaft 3 is disposed forward of the motor 1 to rotate around an axis CL2 extending in vertical direction. The second gear shaft 3 extends vertically and is provided at its upper end portion with a second gear 3a that engages the first gear 2a. The second gear 3a is, for example, configured as a spur gear of greater diameter than the first gear 2a. In addition, outer peripheral surface of the second gear shaft 3 is provided below the second gear 3a and forward of the motor 1 with a worm 3b configured as a worm gear.

The worm 3b is engaged by a worm wheel (helical gear) 4a rotatable around an axis CL3 extending in lateral direction. The worm wheel 4a is joined to a third gear shaft 4 extending along the axis CL3, so that the third gear shaft 4 rotates integrally with the worm wheel 4a. Rotation of the third gear shaft 4 is transmitted through a differential mechanism or the like to the left and right wheels (front wheels) 103 (FIG. 2). As indicated by thick line T1 in FIG. 1, this configuration enables the vehicle to travel by transmitting torque of the motor 1 to the wheels 103 through the first gear shaft 2, first gear 2a, second gear 3a, second gear shaft 3, worm 3b, worm wheel 4a and third gear shaft 4.

FIG. 3 is a cross-sectional diagram showing more specifically a configuration of the vehicle drive apparatus 100, in particular, the motor 1 of FIG. 1. As shown in FIG. 3, the rotor 10 of the motor 1 includes a rotor hub 11 and a rotor core 15. The rotor hub 11 includes a substantially cylinder-shaped shaft portion 12 centered on the axis CL1, a cylindrical portion 13 of larger diameter than and coaxial with the shaft portion 12, and a substantially disk-shaped plate portion 14 that extends radially to connect the shaft portion 12 and cylindrical portion 13. The rotor core 15 is a substantially cylinder-shaped rotor iron core centered on the axis CL1. The rotor core 15 is fitted on and fastened to (for example, serration coupling) an outer peripheral surface of the cylindrical portion 13 of the rotor hub 11 so as to rotate integrally with the rotor hub 11.

The motor 1 is an interior permanent magnet synchronous motor, and multiple circumferentially spaced permanent magnets 16 are embedded in the rotor core 15. A sensor 16 for detecting a rotational position (rotational angle) of the rotor 10 is provided above the rotor core 15. The configuration of the motor 1 is not limited to the above configuration. Alternatively, it is possible instead to use as the motor 1 one having no magnets, such as a synchronous reluctance motor or switched reluctance motor.

The stator 20 of the motor 1 has a stator core 21 formed in substantially cylindrical shape centered on the axis CL1 and disposed across a gap of predetermined radial length from an outer peripheral surface of the rotor core 15. The stator core 21 is a fixed iron core whose inner peripheral surface is formed with multiple circumferentially spaced radially outward directed slots. A winding 22 (coil) is formed in the slots as a concentrated winding or distributed winding. Upper and lower ends of the winding 22 protrude upward and downward of upper and lower ends of the stator core 21. The rotor 10 rotates when a revolving magnetic field is generated by passing three-phase alternating current through the winding 22. A shaft 6 is disposed along the axis CL1 inside the rotor 10.

The motor 1 is accommodated in a case 30. The case 30 includes an upper case 31 and a lower case 32 that are vertically separable. The upper case 31 and the lower case 32 are joined by bolts 32a disposed at peripheral portions of the upper case 31 and the lower case 32. The stator core 21 is fastened to the lower case 32 by through-bolts 32b. At a middle region of the lower case 32, a bearing support 33 is provided so as to project upward and is formed in a substantially cylindrical shape centered on the axis CL1.

Bearings 41 and 42 of small diameter and large diameter are provided at an inner peripheral surface and an outer peripheral surface of the bearing support 33, respectively. A lower end portion of the shaft 6 is rotatably supported centered on the axis CL1 via the bearing 41. A bottom portion of the rotor 10 is rotatably supported centered on the axis CL1 via the bearing 42. Configurations of support portions of the shaft 6 and the rotor 10 are described later in detail.

An opening 31a is provided along the axis CL1 at a middle region of the upper case 31. A shaft support 34 formed in a substantially truncated cone shape is provided in the opening 31a of the upper case 31 to extend downward and radially inward. A cover 35 is attached to an upper surface of the upper case 31 so as to close the opening 31a by bolts 35a.

The first gear shaft 2 formed in a substantially cylindrical shape centered on the axis CL1 is situated between the shaft support 34 and the cover 35. Upper and lower end portions of the first gear shaft 2 are respectively rotatably supported through taper roller bearings 43 and 44 by the cover 35 and the shaft support 34. Inner peripheral surface of the first gear 2a between the upper and lower taper roller bearings 43 and 44 is coupled to outer peripheral surface of the first gear shaft 2 through splines, so that the first gear shaft 2 and first gear 2a rotate integrally.

Splines 61 are formed on outer peripheral surface of upper end portion of the shaft 6, and splines 63 of greater diameter than the splines 61 are additionally formed thereunder in the manner of sandwiching an intervening step 62. A protrusion 64 projecting radially outward beyond the splines 63 is provided under the splines 63. The splines 61 of the upper end portion of the shaft 6 are fitted in splines 2b of inner peripheral surface of the first gear shaft 2, so that the shaft 6 rotates integrally with the first gear shaft 2. Since the step 62 of the shaft 6 abuts bottom face of the first gear shaft 2, upward movement of the shaft 6 is prevented during the rotation.

A planetary gear mechanism 50 is interposed in the torque transmission path between the rotor 10 and the shaft 6. The planetary gear mechanism 50 includes a sun gear 51 and a ring gear 52, formed in cylindrical shapes centered on the axis CL1, multiple circumferentially spaced planetary gears 53 disposed between the sun gear 51 and the ring gear 52, multiple circumferentially spaced planetary shafts 54 extending parallel to axis CL1 for vertically retaining and rotatably supporting the planetary gears 53, and a carrier 55 formed in a substantially cylindrical shape centered on the axis CL1 and connected to upper end portion of the multiple circumferentially spaced planetary shafts 54, for retaining the multiple circumferentially spaced planetary shafts 54.

The sun gear 51 is formed on outer peripheral surface of the shaft portion 12 of the rotor hub 11. A ring body 36 formed in a substantially cylindrical shape centered on the axis CL1 is bolted to lower end surface of the shaft support 34 of the upper case 31, and the ring gear 52 is formed on inner peripheral surface of the ring body 36. Splines 56 are formed on inner peripheral surface of the carrier 55. The splines 63 of the shaft 6 are fitted in the splines 56, so that the carrier 55 rotates integrally with the shaft 6. Since the splines 56 are located between bottom face of the first gear shaft 2 and the protrusion 64 of the shaft 6, the carrier 55 is vertically restrained during the rotation.

Owing to the aforesaid configuration, rotation of the rotor 10 is transmitted through the sun gear 51, planetary gears 53 and carrier 55 to the shaft 6, whereby rotation of the rotor 10 is changed at a predetermined reduction ratio and the shaft 6 rotates. In addition, rotation of the shaft 6 is output through the first gear shaft 2, first gear 2a and second gear 3a and transmitted to the wheels 103.

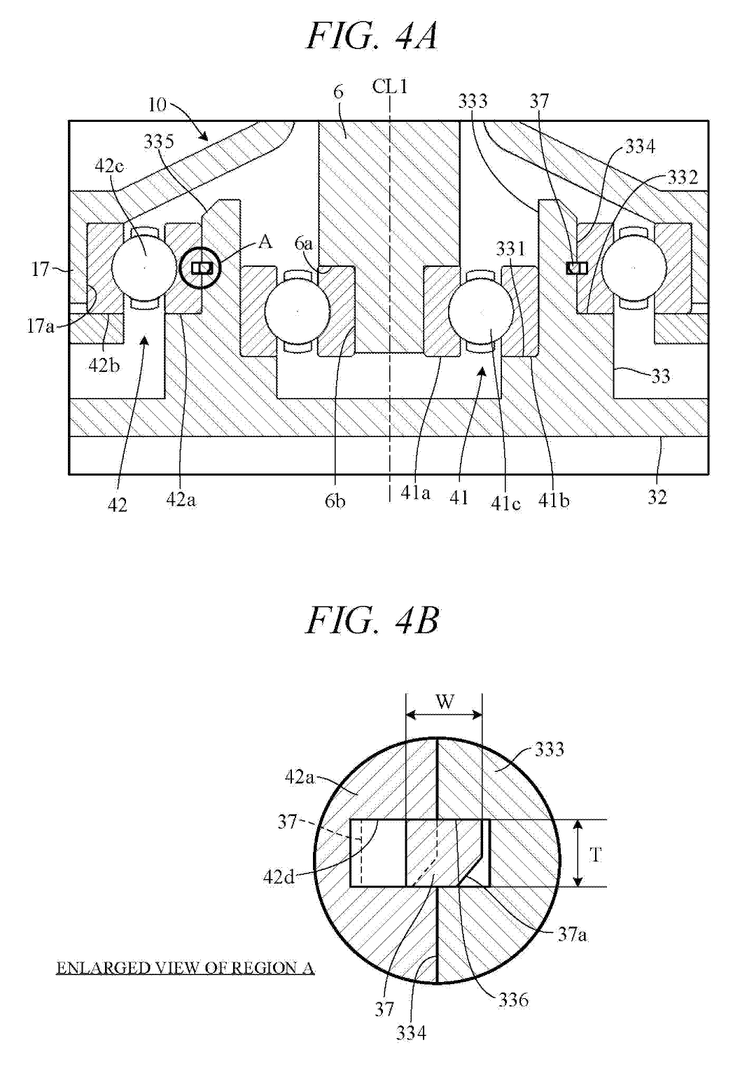

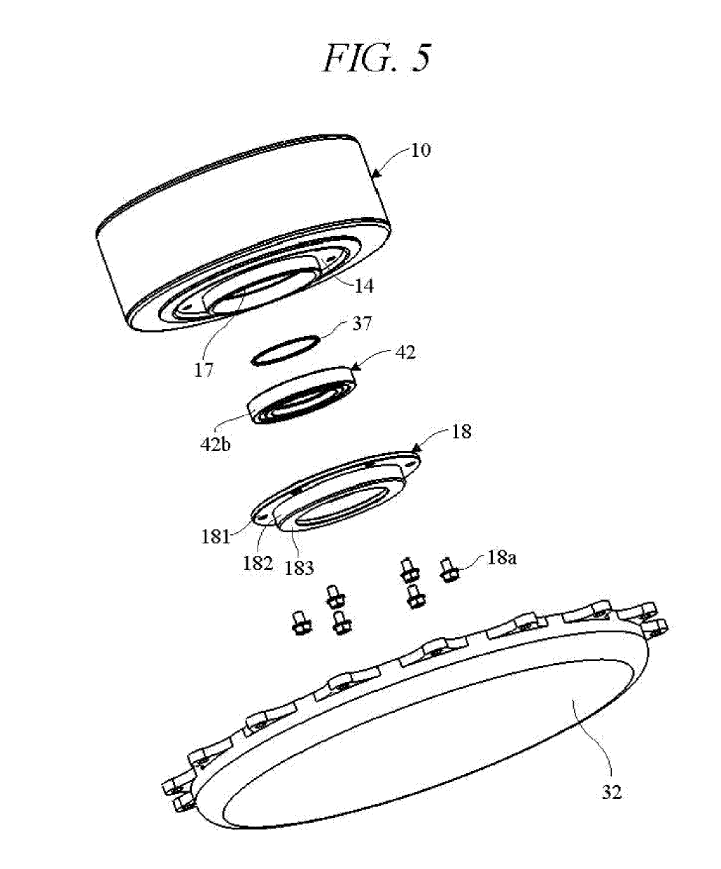

Configuration of the support portion that rotatably supports the rotor 10 and the shaft 6 is explained in detail below. FIG. 4A is an enlarged view of region IV of FIG. 3 including the bearings 41 and 42. As shown in FIG. 4A, a step 331 and a step 332 are provided on inner peripheral surface and outer peripheral surface respectively of the bearing support 33 provided to project from upper surface of the lower case 32. A cylindrical fitting surface 333 and a cylindrical fitting surface 334, both centered on axis CL1, are formed above the step 331 and the step 332, respectively.

Outer peripheral surface of an outer ring 41b of the bearing 41 is fitted on the fitting surface 333 of the bearing support 33. The bearing 41 is, for example, a deep groove ball bearing including an inner ring 41a, the outer ring 41b and balls (rigid spheres) 41c. The bearing 41 can bear radial load and thrust load. The inner ring 41a is attached to lower end portion of the shaft 6 extending vertically along the axis CL1 inside the rotor 10. More specifically, a step 6a is provided at lower end portion of the shaft 6, a fitting surface 6b of cylindrical shape centered on the axis CL1 is formed below the step 6a, and inner peripheral surface of the inner ring 41a is fitted on the fitting surface 6b. Self-weight of the shaft 6 acts on the bearing 41.

Inner peripheral surface of an inner ring 42a of the bearing 42 is fitted on the fitting surface 334 of the bearing support 33. The bearing 42 is, for example, a deep groove ball bearing including the inner ring 42a, an outer ring 42b and balls (rigid spheres) 42c. The bearing 42 can bear radial load and thrust load. Upper end surface of the bearing support 33 at upper part of the fitting surface 334 is provided therearound with a tapered portion 335 sloped at a predetermined angle (e.g., 45°) relative to axis CL1. FIG. 4B is an enlarged view of region A of FIG. 4A. As shown in FIG. 4B, a groove 42d and a groove 336 are provided to predetermined depths in and completely around inner peripheral surface of the inner ring 42a and outer peripheral surface the fitting surface 334, respectively. The positions of the grooves 42d and 336 are the same in the axial direction.

In a state with the inner ring 42a fitted to a predetermined position in the fitting surface 334, i.e., in a state with lower end surface of the inner ring 42a abutting the step 331, a ring (snap ring) 37 is fitted in the grooves 42d and 336 so as to straddle the grooves 42d and 336. The ring 37 is a snap ring partially cut away circumferentially and formed in a substantially C-shape to be expandable and contractible. Radial length (width W) of the ring 37 is approximately equal to depth of the grooves 42d and 336. Axial direction length of the ring 37 (thickness T) is approximately equal to width of the grooves 42d and 336. A tapered portion 37a is provided at a radially inward corner portion of lower end surface of the ring 37 to enable smooth sliding of the ring 37 along the fitting surface 334. The ring 37 of FIG. 4B (solid line) is shown in a condition not under action of an external expanding or contracting force.

As the inner ring 42a moves along the fitting surface 334 during fitting thereon, the ring 37 expands in diameter while sliding along the tapered portion 335 and comes to be wholly accommodated in the groove 42d as indicated by dashed line in FIG. 4B. Once the inner ring 42a is fitted to predetermined position, more specifically, once lower end surface of the inner ring 42a abuts on the step 332 of the bearing support 33, axial positions of the groove 42d and groove 336 coincide and the ring 37 contracts elastically. As a result, a radial part of the ring 37 enters the groove 336 and the ring 37 restrains vertical position of the inner ring 42a relative to the bearing support 33.

As shown in FIGS. 3 and 4A, a bearing support 17 formed in a substantially cylindrical shape centered on axis CL1 is provided to project downward from lower end surface of the plate portion 14 of the rotor hub 11. As shown in FIG. 4A, a fitting surface 17a of cylindrical shape centered on axis CL1 is formed on inner peripheral surface of the bearing support 17, and outer peripheral surface of the outer ring 42b of the bearing 42 is fit on the fitting surface 17a. In this state with outer peripheral surface of the outer ring 42b fitted on the fitting surface 17a, upper end surface of the outer ring 42b abuts lower end surface of the plate portion 14, and self-weight of the bearing 42 acts on the rotor 10.

As shown in FIG. 3, a bearing cover 18 is attached by bolts 18a to lower end surface of the plate portion 14 of the rotor hub 11 radially outward of the bearing support 17. FIG. 5 is an exploded perspective view of a main part of FIG. 3. As shown in FIGS. 3 and 5, the bearing cover 18 includes a flange 181 fastened to the plate portion 14, a peripheral wall 182 formed in a substantially cylindrical shape and extending downward from radial inward edge of the flange 181, and a plate 183 formed in a substantially ring-shape and extending radially inward from lower end portion of the peripheral wall 182. Upper surface of the plate 183 abuts lower end surface of the outer ring 42b of the bearing 42, whereby upward movement of the rotor 10 relative to the bearing 42 is prevented and axial position of the rotor 10 is restrained.

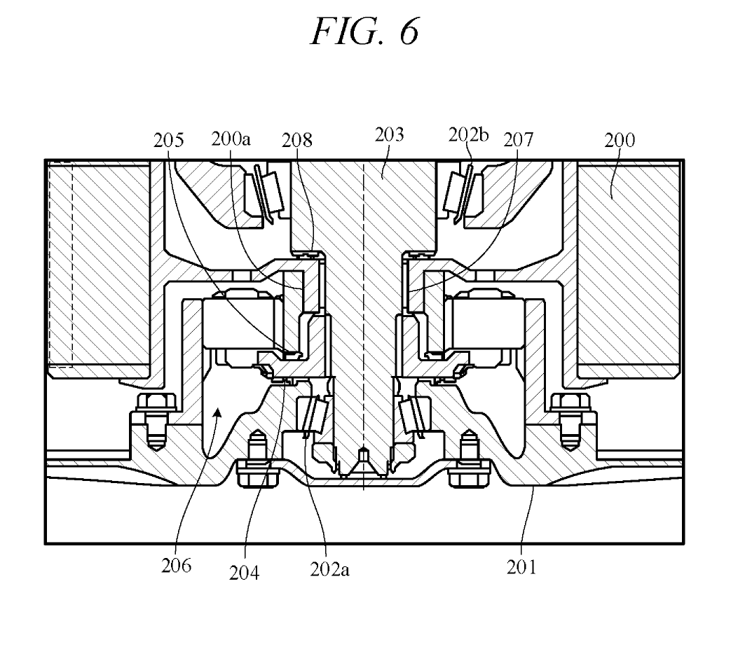

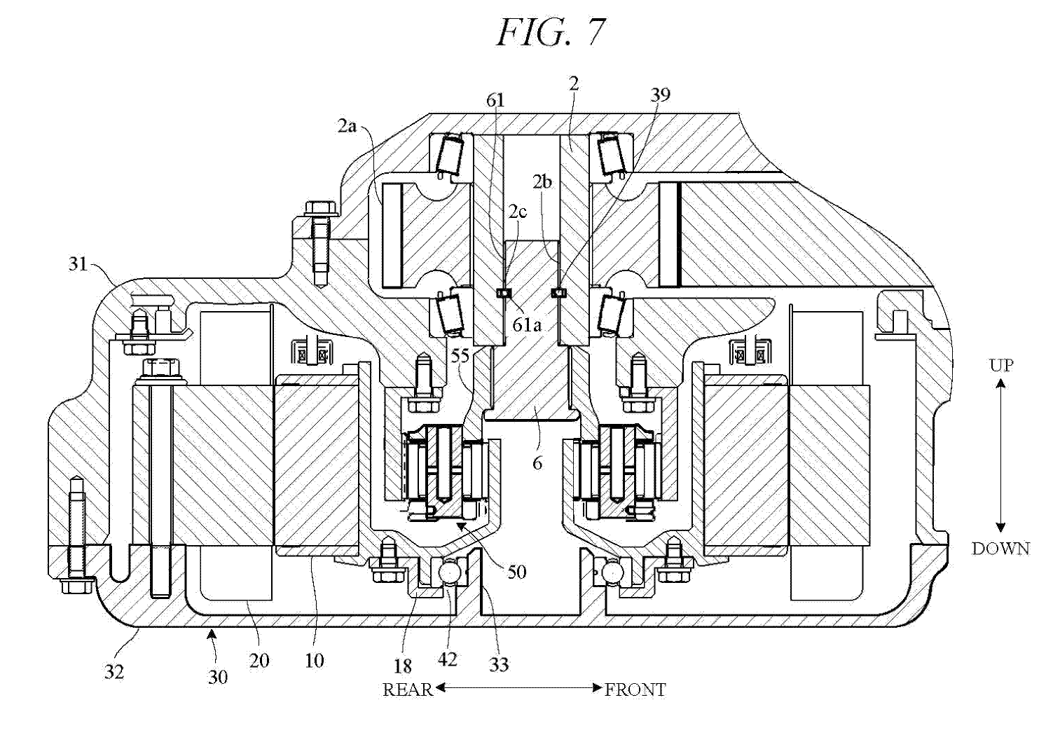

Thus in the present embodiment, the rotor 10 of the motor 1 is rotatably supported from the lower case 32 via the bearing 42. In other words, the rotor 10 is supported by the lower case 32 in gravity direction through the bearing 42. Therefore, unlike in the configuration shown in FIG. 6 as an example for comparison with the present embodiment, provision of a thrust needle bearing for supporting the rotor in gravity direction is unnecessary and bearing loss can be reduced.

In the example configuration of FIG. 6, a shaft 203 is supported by a lower case 201 through taper roller bearings 202a and 202b, and a planetary gear mechanism 206 is rotatably supported on upper surface of the lower case 201 through thrust needle bearings 204 and 205. In addition, a shaft 200a of a rotor 200 is rotatably supported relative to the shaft 203 through a needle bearing 207 and a thrust needle bearing 208. Loss of a thrust needle bearing is large because of difference in circumferential velocity arising between inside and outside of the needles. Therefore, in the case of using the thrust needle bearings 204, 205 and 208 as in FIG. 6, loss is greater than in the case of using deep groove ball bearings (bearings 41 and 42) as in the present embodiment, and loss becomes still larger particularly when using multiple thrust needle bearings (bearings 204, 205 and 208).

Moreover, in the configuration of FIG. 6, the rotor 200 is supported from the lower case 201 through the taper roller bearings 202a and 202b, the shaft 203 and the needle bearing 207. This leads to increased production cost because tolerance grade of these multiple components must be upgraded in order to enhance accuracy of clearance between the rotor 200 and a stator. The present embodiment is advantageous regarding this aspect because owing to the fact that the rotor 10 is supported from the lower case 32 (bearing support 33) via the bearing 42 as shown in FIG. 3, accuracy of clearance between the rotor 10 and stator 20 can be easily improved with minimal increase of production cost.

Assembly procedure of the vehicle drive apparatus 100 according to the present embodiment is explained in the following. First, the stator 20 (stator core 21) is fixed to the lower case 32 shown in FIG. 3 by the through-bolts 32b. Next, the bearing 42 is attached to the bearing support 17 of bottom portion of the rotor 10 by press-fitting. Then the bearing cover 18 is attached to the plate portion 14 of the rotor 10 with the bolts 18a. Then the bearing 41 is attached to the bearing support 33 of the lower case 32 by press-fitting. Next, the bearing 42 is attached to the bearing support 33 of the lower case 32 together with the rotor 10. At this time, the ring 37 fitted in the groove 42d of the inner ring 42a of the bearing 42 (FIG. 4B) fits in the groove 336 of the fitting surface 334 of the bearing support 33, thereby fixing the bearing 42 to the lower case 32 through the ring 37.

Next, the ring body 36 formed with the ring gear 52 is bolted to bottom surface of the shaft support 34 of the upper case 31. Then lower end portion of the shaft 6 is inserted into the bearing 41. Then the splines 56 of the carrier 55 integral with the planetary gears 53 of the planetary gear mechanism 50 are fitted along the splines 63 on the outer peripheral surface of the shaft 6. Next, the lower case 32 and upper case 31 are fastened with the bolts 32a. Finally, the taper roller bearing 43, first gear 2a and taper roller bearing 44 are successively fitted on the first gear shaft 2, whereafter the first gear shaft 2 is fitted on the shaft 6 and the cover 35 is attached to top of the upper case 31 with the bolts 35a.

The present embodiment can achieve advantages and effects such as the following:

(1) The vehicle drive apparatus 100 includes: the electric motor 1 including the rotor 10 that rotates centered on the axis CL1 extending in vertical direction and the stator 20 disposed around the rotor 10; the shaft 6 disposed inside the rotor 10 to be rotatable centered on the axis CL1 and to extend along axis CL1; the planetary gear mechanism 50 for transmitting torque of the motor 1 to the shaft 6; the upper case 31 and lower case 32 surrounding the stator 20; and the bearing 42 attached to the lower case 32 for supporting bottom portion of the rotor 10 to be rotatable centered on axis CL1 while bearing weight of the rotor 10 (FIG. 3).

This configuration can lower loss by bearings during rotor rotation compared to that in, for example, a configuration such as shown in FIG. 6 that rotatably supports the rotor 200 from the shaft 203 in gravity direction via the thrust needle bearings 204, 205 and 208. Moreover, accuracy of clearance between the rotor 10 and the stator 20 can be easily enhanced because the rotor 10 is supported from the lower case 32 via the bearing 42.

(2) The lower case 32 includes the bearing support 33 having the fitting surface 334 of cylindrical shape centered on the axis CL1 (FIG. 4A). Bottom portion of the rotor 10 includes the bearing support 17 having the cylindrical fitting surface 17a facing the fitting surface 334 (FIG. 4A). The bearing 42 is configured as a deep groove ball bearing including the inner ring 42a fitted on the fitting surface 334 and the outer ring 42b fitted on the fitting surface 17a (FIG. 4A). The bearing 42 can therefore bear radial load and thrust load and reliably support the rotor 10 rotating about the vertical axis CL1, along with the self-weight thereof.

(3) The vehicle drive apparatus 100 further includes the bearing cover 18 attached to bottom portion of the rotor 10 so as to cover bottom surface of the outer ring 42b of the bearing 42 (FIGS. and 5). This prevents upward movement of the rotor 10 relative to the case 30. Upward movement of the shaft 6 relative to the case 30 is prevented by abutment of the step 62 of the shaft 6 onto bottom surface of the first gear shaft 2 (FIG. 3).

(4) The groove 336 and the groove 42d are provided over whole circumferences on the fitting surface 334 of the bearing support 33 and inner peripheral surface of the inner ring 42a, respectively, and the ring 37 is fitted in both the groove 336 of the fitting surface 334 and groove 42d of the inner ring 42a (FIG. 4A). The inner ring 42a can therefore be easily fixed to the lower case 32. Moreover, the ring 37 can radially expand and contract elastically, so that when, in a state with the ring 37 fitted in the groove 42d, the inner ring 42a of the bearing 42 is fitted on the bearing support 33, the ring 37 fits in the groove 336, whereby assembly of the rotor 10 into the vehicle drive apparatus 100 is facilitated.

(5) The vehicle drive apparatus 100 further includes the first gear shaft 2 that rotates integrally with the shaft 6. The first gear shaft 2 has inner peripheral surface of cylindrical shape centered on axis CL1 (splines 2b) fitted on the splines 61 of shaft 6, is disposed above the rotor 10, and has the first gear 2a (FIG. 3). Torque of the motor 1 can therefore be readily extracted through the shaft 6 and first gear shaft 2 to outside the motor 1.

(6) The bearing support 33 of the lower case 32 includes, inside the fitting surface 334 in radial direction, the fitting surface 333 centered on the axis CL1 (FIG. 4A). The vehicle drive apparatus 100 further includes the bearing 41 (deep groove ball bearing) having the inner ring 41a fitted on lower outer peripheral surface (fitting surface 6b) of the shaft 6 and outer ring 41b fitted on fitting surface 333. Therefore, the shaft 6 can be rotatably supported from the lower case 32 in gravity direction. Since the bearings 41 and 42 are respectively disposed radially inward and outward of the bearing support 33, the pair of bearings 41 and 42 can be compactly installed in a limited space without enlarging overall apparatus size in axial direction.

In the aforesaid embodiment, the shaft 6 is supported from the lower case 32 through the bearing 41. However, a support structure of the shaft 6 is not limited to this configuration. FIG. 7 is a diagram showing a modification of FIG. 3. In FIG. 7, grooves 2c and 61a are provided over whole circumferences on inner peripheral surface (splines 2b) of the first gear shaft 2 and outer peripheral surface (splines 61) of the shaft 6, respectively, and a ring (snap ring) 39 similar to the circumferentially partially cut away ring 37 is fitted in the grooves 2c and 61a. The shaft 6 is therefore supported on inner peripheral surface of the first gear shaft 2 through the ring 39.

Owing to the provision of the grooves 2c and 61a over whole circumferences on outer peripheral surface of the shaft 6 and inner peripheral surface of the first gear shaft 2, and the fitting of the ring 39 in both of the grooves 2c and 61a in this manner, need for the bearing 41 (FIG. 3) for supporting the shaft is obviated. As a result, structure around the bearing 42 can be simplified and length of the shaft 6 shortened.

The structure according to FIG. 7 can be assembled, for example, by attaching the ring 39 to the groove 61a and thereafter inserting the shaft 6 fitted with the carrier 55 into the first gear shaft 2 while contracting the ring 39, thereby fitting the ring 39 in the groove 2c. Alternatively, it can be assembled by attaching the ring 39 to the groove 2c of the first gear shaft 2 and thereafter inserting the shaft 6 into the first gear shaft 2, thereby fitting the ring 39 in the groove 61a.

In the aforesaid embodiment, the case 30 of the motor 1 is configured by the upper case 31 and lower case 32. However, a case can be of any structure insofar as it has a side wall and a bottom wall surrounding the stator of the motor. The planetary gear mechanism 50 serving as a torque transmission mechanism for transmitting torque of the motor 1 to the shaft 6 is not limited to the configuration described in the foregoing. In the aforesaid embodiment, deep groove ball bearings are used as the bearings 41 and 42, but other type of bearing capable of bearing radial load and thrust load can be used instead. Bearings can be of any configuration insofar they can be attached to the bottom wall (lower case 32) of the case 30 and support bottom portion of the rotor 10 so as to be rotatable centered on the axis CL1 while bearing a weight of the rotor.

Although in the aforesaid embodiment, the bearing support 33 having the fitting surface 334 (first cylindrical surface) is provided on the lower case 32, a first bearing support is not limited to the aforesaid configuration. Although in the aforesaid embodiment, the bearing support 17 is provided on bottom portion of the rotor 10, a second bearing support having the fitting surface 17a (second cylindrical surface) facing the fitting surface 334 is not limited to the aforesaid configuration. Although in the aforesaid embodiment, the bearing cover 18 is attached to the bottom portion of the rotor 10, a bearing fixing member is not limited to the aforesaid configuration insofar as attached to bottom portion of the rotor so as to cover bottom surface of the outer ring of the bearing. Although in the aforesaid embodiment, the ring 37 is fitted in the groove 336 of the bearing support 33 and the groove 42d of inner peripheral surface of the inner ring 42a, a groove and a ring member are not limited to the above configurations.

In the aforesaid embodiment, the shaft 6 is fitted in the splines 2b of inner peripheral surface of the first gear shaft 2. However, a gear shaft is not limited to the configuration of the aforesaid first gear shaft 2 insofar as it has a cylindrical inner peripheral surface centered on the axis and is disposed above the rotor to rotate integrally with the shaft. In the aforesaid embodiment (FIG. 3), the bearing 42 (first deep groove ball bearing) is supported on the fitting surface 334, i.e., outer peripheral surface of the bearing support 33, and the bearing 41 (second deep groove ball bearing) is supported on the fitting surface 333 (third cylindrical surface), i.e., inner peripheral surface of the bearing support 33. However, a third bearing support for supporting the bearing 41 can be provided separately from a first bearing support for supporting the bearing 42. In the aforesaid embodiment (FIG. 7), the ring 39 is fitted in the groove 61a of outer peripheral surface of the shaft 6 and the groove 2c of inner peripheral surface of the first gear shaft 2, but a groove and a ring member are not limited to this configuration.

The above embodiment can be combined as desired with one or more of the above modifications. The modifications can also be combined with one another.

According to the present invention, a rotor of an electric motor of a vehicle drive apparatus that rotates about an axial line extending in a vertical direction can be supported in a good manner reducing bearing loss.

Above, while the present invention has been described with reference to the preferred embodiments thereof, it will be understood, by those skilled in the art, that various changes and modifications may be made thereto without departing from the scope of the appended claims.

What is claimed is:

1. A vehicle drive apparatus, comprising:
an electric motor including a rotor rotating about an axial line extending in a vertical direction and a stator disposed around the rotor;
a shaft disposed rotatably about the axial line inside the rotor and extended along the axial line;
a torque transmission mechanism configured to transmit a torque of the electric motor to the shaft;
a case including a side wall and a bottom wall and configured to surround the stator; and
a bearing attached to the bottom wall to support a bottom portion of the rotor rotatably about the axial line while bearing a weight of the rotor.

2. The vehicle drive apparatus according to claim 1, wherein
the bottom wall includes a first bearing support having a first cylindrical surface centered on the axial line,
the bottom portion of the rotor includes a second bearing support having a second cylindrical surface facing the first cylindrical surface; and
the bearing is a deep groove ball bearing including an inner ring fitted on the first cylindrical surface and an outer ring fitted on the second cylindrical surface.

3. The vehicle drive apparatus according to claim 2, further comprising a bearing fixing member attached to the bottom portion of the rotor so as to cover a bottom surface of the outer ring.

4. The vehicle drive apparatus according to claim 2, wherein
grooves are provided over whole circumferences on the first cylindrical surface and an inner peripheral surface of the inner ring, respectively, and
the vehicle drive apparatus further comprises a ring member fitted into the grooves.

5. The vehicle drive apparatus according to claim 4, wherein the ring member is configured to be elastically expandable in a radial direction.

6. The vehicle drive apparatus according to claim 2, further comprising a gear shaft disposed above the rotor and including a gear and an inner peripheral surface of a cylindrical shape centered on the axial line fitted on an outer peripheral surface of the shaft so as to rotate integrally with the shaft.

7. The vehicle drive apparatus according to claim 2, wherein
the bottom wall further includes a third bearing support having a third cylindrical surface centered on the axial line inside the first cylindrical surface in a radial direction,
the bearing is a first deep groove ball bearing, and
the vehicle drive apparatus further comprises a second deep groove ball bearing including an inner ring fitted on an outer peripheral surface of a bottom portion of the shaft and an outer ring fitted on the third cylindrical surface.

8. The vehicle drive apparatus according to claim 6, wherein
grooves are provided over whole circumferences on the outer peripheral surface of the shaft and the inner peripheral surface of the gear shaft, respectively, and
the vehicle drive apparatus further comprises a ring member fitted into the grooves.

9. The vehicle drive apparatus according to claim 2, wherein
the torque transmission mechanism includes a planetary gear mechanism having a sun gear and a carrier,
the sun gear is formed at an outer peripheral surface of a shaft portion centered on the axial line provided at an inner diameter side end portion of the bottom portion of the rotor, and
the carrier is fitted on an outer peripheral surface of the shaft.
